(19) United States
(12) Patent Application Publication
(10) Pub. No.: US 2002/0132126 A1
(43) Pub. Date: Sep. 19, 2002

(54) Preventing corrosion with beneficial biofilms

(76) Inventors: Thomas K. Wood, Tolland, CT (US); Dogan Ornek, Ashford, CT (US); Florian B. Mansfeld, Marina Del Rey, CA (US)

Correspondence Address: PENNIE AND EDMONDS, 1155 AVENUE OF THE AMERICAS, NEW YORK, NY, 100362711

(21) Appl. No.: 10/002,317

(22) Filed: Oct. 25, 2001

Related U.S. Application Data
(60) Provisional application No. 60/243,881, filed on Oct. 26, 2000.

(51) Int. Cl. B05D 1/18; B32B 15/04

(52) U.S. Cl. 428/457; 427/430.1

(57) ABSTRACT

The present invention provides bacteria which form a protective biofilm that prevent and/or reduce corrosion of metal surfaces. The present invention also provides bacteria, which form a protective biofilm on metals that secrete polyanionic chemical compositions that are inhibitors of metal corrosion.

This application claims the benefit under 35 U.S.C. §119(e) of U.S. Provisional Application Serial No. 60/243,881, filed Oct. 26, 2000.

### BACKGROUND OF THE INVENTION

1. Field of the Invention

The present invention relates to preventing and/or reducing metal corrosion. More particularly, the present invention provides metals that include protective biofilms and methods for preventing and/or reducing corrosion of metal with protective biofilms.

2. Description of the Related Art

Corrosion damage to materials such as metals, concrete and mortar is a significant expense in the modern economy. For example, the annual cost of corrosion damage has been estimated to be a substantial fraction of the gross national product. Superior methods for protecting corrosion sensitive materials, particularly metals, from corrosion damage could significantly reduce these costs.

A wide variety of anionic organic and inorganic compounds such as carboxylates (e.g.,(C₆-C₁₀) straight chain aliphatic monocarboxylic acids, (C₃-C₁₄) dicarboxylic acids, polymaleic acid and polyacrylic acid), polypeptides and polyphosphate inhibit corrosion of metals such as steel, copper and aluminum (Sekine et al., Electrochem. Soc., Vol. 139, 11:3167-3173, 1992, which is herein incorporated by reference; Hefter et al., Corrosion. 53, 8:657-667, 1997, which is herein incorporated by reference; Wranglen, “An Introduction to the Corrosion and Protection of Metals”, Halsted Press, New York, N.Y., 1972). Thus, application of these inhibitors to metals is one approach to reducing corrosion damage.

Another approach to reducing corrosion damage is preventing the growth of biofilms on corrosion sensitive materials such as metals. Biofilms, which consist of aerobic bacteria rapidly develop on metal surfaces in natural environments, and have been implicated in increasing the corrosion rate of these surfaces. Metabolically active bacteria display an increased tendency to attach to surfaces and, with sufficient nutrients, produce exopolysaccharides to form mature biofilms. Thus, biofilms are microbial populations, enclosed in an exopolysaccharide matrix, that adhere to surfaces. The exopolysaccharide assists in fixing bacteria to the surface and is essential for further biofilm development.

Microorganisms are believed to increase the rate of electrochemical reactions, thus increasing the corrosion rate of most metals without changing the corrosion mechanism (Little et al., Int. Mat Rev., 36, 6, 1, 1991). Corrosion may also occur because of non-uniform biofilm formation and microcolony development on metal surfaces, which leads to oxygen concentration gradients and differential aeration cells near the metal surface. Typically, regions of aerobic biofilms located near metal surfaces are anoxic because of oxygen depletion caused by bacterial respiration. Sulfate reducing bacteria can develop in these anaerobic regions and cause significant corrosion damage to a wide variety of metal surfaces.

Conventional strategies to combat corrosion caused by microorganisms include pH modification, redox potential manipulation, inorganic coatings, cathodic protection and biocides. Protective coatings such as paints and epoxies are commonly used but application and maintenance are expensive. Cathodic protection requires stimulating a cathodic reaction on the metal surface by coupling with a sacrificial anode or by providing current from an external power supply through a corrosion resistant anode. The current lowers the electrochemical potential on the metal surface, thus preventing metal cation formation and consequent corrosion.

Biocides are probably the most common method of reducing corrosion caused by microorganisms. Oxidizing biocides like chlorine, chloramines, and chlorinated compounds are often used in freshwater systems. Chlorine and chlorinated derivatives are the most cost effective and efficient biocides. However, the activity of chlorine and chlorinated compounds depends on pH, light and temperature and these halogen derivatives do not usually prevent biofilm growth.

Non-oxidizing biocides such as quaternary salts, amine-type compounds and anthraquinones are stable and can be used in a variety of environments. However, these biocides are costly and may cause significant environmental damage.

Another strategy to control corrosion caused by microbes is suppressing growth of particularly harmful microorganisms through nutrient manipulation. Alternatively, polymers that prevent bacterial attachment to a surface may be used to coat the surface and thus prevent biofilm formation.

Surprisingly, recent investigations have demonstrated that aerobic bacteria can inhibit metal corrosion by forming protective biofilms on metal surfaces such as steel, copper and aluminum (K. M. Ismail et al., Electrochimica Acta, in press; K. M. Ismail et al., submitted to Corrosion; A. Jayaraman et al., Journal of Industrial Microbiology 18:396-401, 1997; A. Jayaraman et al., Journal of Applied Microbiology 84:485-492, 1997; A. Jayaraman et al, Applied Microbiology & Biotechnology 47:62-68, 1997, A. Jayaraman et al., Applied Microbiology & Biotechnology 52:787-790, 1997 which are herein incorporated by reference). The aerobic bacteria may deplete oxygen that could otherwise oxidize the metal through respiration (A. Jayaraman et al., Applied Microbiology & Biotechnology, 48:11-17, 1997 which is herein incorporated by reference).

However, oxygen depletion may also create an opportunity for anaerobic sulfate reducing bacteria to colonize the metal surface and cause significant corrosion damage. Thus, the use of biofilms to inhibit corrosion of metal may be counter-acted by corrosion caused by sulfate reducing bacteria. Recently, in-a possible solution to the above problem, genetically engineered aerobic bacteria, which secrete antimicrobial proteins that inhibit growth of sulfate reducing bacteria, have been used to form biofilms that prevent generalized corrosion of stainless steel (A. Jayaraman et al., Journal of Industrial Microbiology and Biotechnology, 22:167-175, 1999, A. Jayaraman et al., Applied Microbiology and Biotechnology, 52:267-275 1999, which are herein incorporated by reference).

Although the ability of biofilms to reduce or prevent corrosion of steel, copper or aluminum has been recently demonstrated, the use of biofilms to prevent or reduce corrosion of other metals has not yet been investigated. Further, the use of genetically engineered bacteria that secrete polyanionic chemical compositions to form protective biofilms that prevent generalized corrosion of metals has also not yet been investigated. Such inventions would be a significant advance in the art, since biofilms are much less expensive than corrosion inhibitors and biocides, because they are naturally formed and are self-perpetuating.

### SUMMARY OF THE INVENTION

The present invention addresses this need by providing bacteria which form a protective biofilm that prevents and/or reduces corrosion of metal surfaces. The present invention also provides bacteria, which form protective biofilms and secrete polyanionic chemical compositions that are inhibitors of metal corrosion.

In one aspect, the present invention provides a metal, which is not steel, copper or aluminum, that has a substrate with an exterior surface. A protective biofilm is positioned on the exterior surface that reduces corrosion of the exterior surface.

In one embodiment, the metal is brass UNS-C26000. In another embodiment, the biofilm is a bacterium. Preferably, the bacterium is an aerobe, more preferably, the bacterium is Bacillus subtilis or Bacillus licheniformis. Preferably, the biofilm is between about 10 μm and about 20 μm thick.

In another aspect, the present invention provides a method for reducing metal corrosion. In the method, a metal, which is not steel, copper or aluminum with an exterior surface is provided and a protective biofilm is applied on an exterior surface that reduces corrosion.

In one embodiment, the metal is brass UNS-C26000. In another embodiment, the biofilm is a bacterium. Preferably, the bacterium is an aerobe, more preferably, the bacterium is Bacillus subtilis or Bacillus licheniformis. Preferably, the biofilm is between about 10 μm and about 20 μm thick. In one embodiment, the metal is immersed in a liquid. Preferably, the liquid is artificial seawater or Luria-Bertani medium.

In still another aspect, the present invention provides a metal, that is a substrate with an exterior surface. A protective biofilm, which secretes a polyanionic chemical composition is positioned on the exterior surface that reduces corrosion of the exterior surface.

In one embodiment, the metal is aluminum, aluminum alloy, copper, a copper alloy, titanium, a titanium alloy, nickel or a nickel alloy. In another embodiment, the metal is steel. In a preferred embodiment, the steel is mild steel-1010.

Preferably, the bacterium is an aerobe, more preferably, the bacterium is E. coli. In one embodiment, the bacterium has been genetically engineered to secrete the polyanionic chemical composition. In another embodiment, the polyanionic chemical composition is polyphosphate. Preferably, the biofilm is between about 10 μm and about 20 μm thick.

In final aspect, the present invention provides another method for reducing metal corrosion. In the method, a metal with an exterior surface is provided and a protective biofilm is applied on an exterior surface that reduces corrosion. The protective biofilm is a bacterium that secretes a polyanionic chemical composition.

In one embodiment, the metal is aluminum, aluminum alloy, copper, a copper alloy, titanium, a titanium alloy, nickel or a nickel alloy. In another embodiment, the metal is steel. In a preferred embodiment, the steel is mild steel-1010.

Preferably, the bacterium is an aerobe, more preferably, the bacterium is E. coli. In one embodiment, the bacterium has been genetically engineered to secrete the polyanionic chemical composition. In another embodiment, the polyanionic chemical composition is polyphosphate. Preferably, the biofilm is between about 10 μm and about 20 μm thick. In one embodiment, the metal is immersed in a liquid. Preferably, the liquid is artificial seawater or Luria-Bertani medium.

### BRIEF DESCRIPTION OF THE DRAWINGS

FIG. 1 illustrates a corrosion sensitive substrate with an exterior surface that is covered with a protective biofilm.

FIG. 2 illustrates impedance spectra obtained for brass UNS-C26000 during exposure to Vatäanen nen nine salts solution at pH 7.5 for 5.5 days. The spectra are plotted in a Bode plot.

FIG. 3 illustrates impedance spectra obtained for brass UNS-C26000 during exposure to Vatäanen nen nine salts solution at pH 7.5 in the presence of Bacillus subtilis WB600 for 5.5 days. The spectra are plotted in a Bode plot.

FIG. 4 illustrates impedance spectra obtained for brass UNS-C26000 during exposure to Vatäanen nen nine salts solution at pH 7.5 for 10.0 days. The spectra are plotted in a Bode plot.

FIG. 5 illustrates impedance spectra obtained for brass UNS-C26000 during exposure to Vatäanen nen nine salts solution at pH 7.5 in the presence of Bacillus subtilis WB600/pBE92-Asp, which produces polyaspartate for 10 days. The spectra are plotted in a Bode plot.

FIG. 6 illustrates impedance spectra obtained for brass UNS-C26000 during exposure to Vatäanen nen nine salts solution at pH 7.5 in the presence of Bacillus licheniformis which secretes γ-glutamate for 10 days. The spectra are plotted in a Bode plot.

FIG. 7 illustrates the time dependence of the relative corrosion rate 1/Rₚ for brass UNS-C26000 during exposure to Vatäanen nen nine salts solution at pH 7.5 under a number of different conditions.

FIG. 8 illustrates the time dependence of the capacitance C for brass UNS-C26000 during exposure to Vatäanen nen nine salts solution at pH 7.5 under a number of different conditions.

FIG. 9 illustrates the time dependence of E,O, for brass UNS-C26000 during exposure to Vatäanen nen nine salts solution at pH 7.5 under a number of different conditions.

FIG. 10 illustrates impedance spectra obtained for brass UNS-C26000 during exposure to Luria-Bertani medium at pH 6.5 for 8 days. The spectra are plotted in a Bode plot.

FIG. 11 illustrates impedance spectra obtained for brass UNS-C26000 during exposure to Luria-Bertani medium at pH 6.5 for 8 days. The spectra are plotted in a Bode plot.

FIG. 12 illustrates impedance spectra obtained for brass UNS-C26000 during exposure to Luria-Bertani medium at pH 6.5 for 8 days. The spectra are plotted in a Bode plot.

FIG. 13 illustrates the time dependence of the relative corrosion rate 1/Rₚ for brass UNS-C26000 during exposure to Luria-Bertani medium at pH 6.5 under a number of different conditions.

FIG. 14 illustrates the time dependence of the capacitance C for brass UNS-C26000 during exposure to Luria-Bertani medium at pH 6.5 under a number of different conditions.

FIG. 15 illustrates the time dependence of E_{corr}, for brass UNS-C26000 during exposure to Luria-Bertani medium at pH 6.5 under a number of different conditions.

FIG. 16 illustrates the time dependence of E_{corr}, for brass UNS-C26000 during exposure to Luria-Bertani medium at pH 6.5 under a number of different conditions.

FIG. 17 illustrates the time dependence of the relative corrosion rate 1/Rₚ for brass UNS-C26000 during exposure to Luria-Bertani medium at pH 6.5 under a number of different conditions.

### DETAILED DESCRIPTION OF THE INVENTION

Reference will now be made in detail to preferred embodiments of the invention. While the invention will be described in conjunction with the preferred embodiments, it will be understood that it is not intended to limit the invention to those preferred embodiments. To the contrary, it is intended to cover alternatives, modifications, and equivalents as may be included within the spirit and scope of the invention as defined by the appended claims.

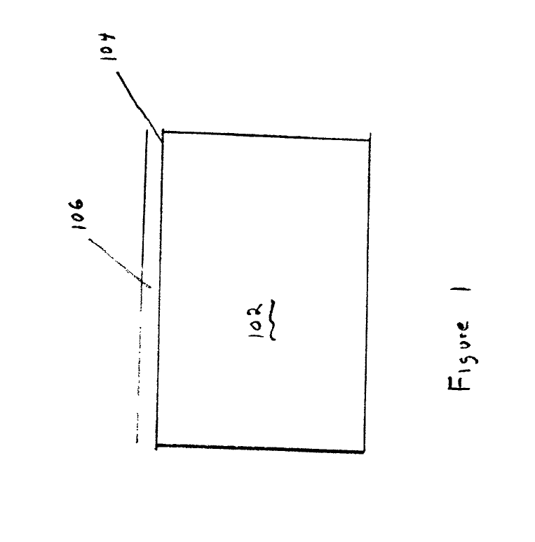

A metal 102 of the present invention is illustrated in FIG. 1. The metal 102 may take any possible form, with at least one exterior surface 104. Thus, for example, the choice of substrate is not restricted by use or shape. The exterior surface of the substrate is also not restricted by use or shape. Generally, as shown in FIG. 1, a protective biofilm 106 is positioned on an exterior surface of the substrate that reduces or prevents corrosion of the exterior surface.

In a preferred embodiment, adherent bacteria enclosed in a polysaccharide coating forms a protective biofilm on the metal. Preferably, the protective biofilm is between about 10 μm and about 20 μm thick. In a preferred embodiment, the protective biofilm is formed from aerobic bacteria.

Preferably, the thickness of protective biofilms may be measured by techniques known in the art such as confocal scanning laser microscopy (A Jayaraman et al., J. Appl. Microbiol., 84:485, 1998; A Jayaraman et al., J. Industrial Microbiology & Biotechnology, 22:167, 1999; U.S. patent application Ser. No. 09/282,277, filed on Mar. 31, 1999). Image processing and analysis of confocal scanning laser microscopy data obtained from biofilms can also be performed by methods known in the art (A Jayaraman et al., J. Appl. Microbiol., 84:485, 1998; A Jayaraman et al., J. Ind. Microbiol. & Biotechnol., 22:167, 1999; U.S. patent application Ser. No. 09/282,277, filed on Mar. 31, 1999).

Generally, in one preferred embodiment, when bacteria form a protective biofilm, the metal is any metal other than copper, aluminum or steel. Preferably, the metal is iron, aluminum alloy, titanium, titanium alloy, copper alloy, nickel, nickel alloy or mixtures thereof. More preferably, the metal is brass UNS-C26000, which refers to a particular grade of brass meeting the industry standard for that designation.

Preferably, when bacteria form a protective biofilm and also secrete an anionic chemical composition, the metal is aluminum, aluminum alloy, titanium, titanium alloy, copper, copper alloy, nickel, nickel alloy, mild steel, stainless steel or mixtures thereof. Preferably, the metal is steel, more preferably, the metal is mild steel-1010, which refers to a particular grade of steel meeting the industry standard for that designation.

In general, bacterium must be compatible with the environment of the metal to reduce or prevent corrosion of an exterior surface of the substrate. For example, if protection of a metal from corrosion in sea water is required, then bacteria must be compatible with sea water. Conversely, if protection of a metal from corrosion in fresh water is required, then bacteria must be compatible with fresh water.

Preferably, the metal is immersed in a liquid. More preferably, the liquid is Vatäanen nen nine salts solution (preferably, at about pH 7.5) or Luria-Bertani medium (preferably, at about pH 6.5).

The selected bacteria should be able to form a biofilm on a surface of the metal. Methods for determining the ability of individual bacteria to form biofilms in various environments are known in the art (Jayaraman et al., Appl. Microbiol Biotechnol., 48:11-17, 1997). Preferably, bacteria from the genus Bacillus, Pseudomonas, Serratia, or Escherichia are used to form biofilms on metals. More preferably, bacteria from the genus Bacillus is used to form a biofilm on a metal. Most preferably, Bacillus subtilis and Bacillus lichenformis are used to form a biofilm on an exterior surface of a metal. In another preferred embodiment, E. coli is used to form a biofilm on an exterior surface of a metal.

Additionally, the bacteria used to form a biofilm should grow under the temperature and pH conditions of the environmental condition of the metal. The temperature, pH, other environmental needs and tolerances of most bacterial species can be routinely ascertained by the skilled artisan, using information known in the art. Thus, one of skill in the art can determine whether a particular bacteria will grow in the metal environment.

Bacteria may be applied to an exterior surface of a substrate by any means by which bacteria can contact the surface. Thus, for example, bacteria may be applied to an exterior surface of a substrate by contacting, spraying, brushing, hosing, or dripping bacteria or a mixture containing bacteria onto the exterior surface of the corrosion sensitive material. Bacteria may be placed on a surface, with scraping to create a space within an existing biofilm or without scraping of the surface.

The biofilm should protect an exterior surface of a metal from corrosion. A preferred method, well known to those of skill in the art, for detecting corrosion of metal surfaces is electrochemical impedance spectroscopy. Electrochemical impedance spectroscopy has been used in laboratory studies of microbially induced corrosion and in corrosion monitoring in the field (A. Jayaraman et al., Appl Microbiol Biotechnol., 48:11-17, 1997). Electrochemical impedance spectroscopy is a non-invasive method that is ideal for measuring corrosion in continuous-culture experiments. Thus, one of skill in the art should be able to readily determine whether a biofilm protects an exterior surface of the metal from corrosion in a particular environment by using methods such as electrochemical impedance spectroscopy.

The anti-corrosive effect of biofilms may be enhanced by using bacteria that secrete a chemical compositions (preferably a polyanionic chemical composition) that reduce corrosion to form biofilms. Bacteria may either naturally secrete a chemical composition that reduces corrosion or may be genetically engineered to secrete a chemical composition that reduces corrosion.

For example, amino acids are well known in the art as effective corrosion inhibitors. Recently, polypeptides such as polyglutamate, polyglycine, polyaspartate or combinations of these amino acids have been shown to be effective in reducing corrosion of metals. Thus, aerobic biofilms that secrete a chemical composition such as polyglutamate, polyglycine, polyaspartate or mixtures of these amino acids may be effective in reducing corrosion.

Polyanions are also well known in the art as effective corrosion inhibitors. Thus, aerobic biofilms that secrete a polyanionic chemical composition may be effective in reducing corrosion. In a preferred embodiment, bacteria that have been genetically engineered to secrete polyanionic chemical compositions, such as polyphosphate, are used to form biofilms on metals.

Siderphores such as parabactin (isolated from Paracoccus denitrificans) and enterobactin (isolated from E. coli) are relatively low molecular weight chelators generated and secreted by bacteria to solubilize ferric ions for transport and can inhibit corrosion of iron. Thus, siderphores may also reduce corrosion of iron.

Siderphore genes may be placed under the control of a strong constitutive promoter and over-expressed in bacteria, which normally secrete these chelators. Alternatively, bacteria may be genetically engineered to secrete a chemical composition that includes a siderphore. Then, these bacteria may be used to form biofilms that protect metals from corrosion.

Bacteria used in the present invention may secrete more than one anti-corrosive agent. Use of bacteria secreting two or more anti-corrosive agents may be advantageous if the two agents synergistically reduce metal corrosion. For example, bacteria may be genetically engineered to produce anti-corrosive agents such as polyaspartate, polyglutamate, polypeptides consisting of these two peptides, parabactin, enterobactin, other siderphores, polyanions such as polyphosphate or mixtures thereof.

Bacteria may be genetically engineered to secrete polypeptides such as polyglutamate or polyaspartate or siderphores or polyanions through recombinant DNA technology, using techniques well known in the art for expressing genes. These methods include, for example, in vitro recombinant DNA techniques, synthetic techniques and in vivo genetic recombination. DNA and RNA encoding nucleotide sequences of anti-corrosive polypeptides, siderphores or components of a polyanion expression system may be chemically synthesized using, for example, commercially available synthesizers.

A variety of host-expression vector systems may be utilized to express anti-corrosive polypeptides, siderphores or polyanions. The expression systems that may be used for purposes of the invention, include but are not limited to, bacteria such as E. coli or B. subtilis transformed with recombinant bacteriophage DNA, plasmid DNA or cosmid DNA expression vectors containing a nucleotide sequence encoding anti-corrosive polypeptides, siderphores or components of a polyanion expression system.

Chemical compositions containing anti-corrosive polypeptides, siderphores or components of a polyanion expression system can be expressed in a procaryotic cell using expression systems known to those of skill in the art of biotechnology. Expression systems that may be useful for the practice of the current invention are described in U.S. Pat. Nos. 5,795,745; 5,714,346; 5,637,495; 5,496,713; 5,334,531; 4,634,677; 4,604,359; 4,601,980, all of which are incorporated herein by reference.

Thus, a number of techniques are known in the art for introducing DNA, including heterologous DNA, into bacterial cells and expressing the resultant gene product. The method for transforming bacteria and expressing chemical compositions of anti-corrosive polypeptide, siderphore or polyanion are not critical to the practice of the current invention. In a preferred embodiment, E. coli is transformed, using plasmids which contain a polyphosphate kinase gene and phosphate-specific transport system. The resultant transfectant then secretes polyphosphate.

### EXAMPLES

The following examples are offered solely for the purpose of illustrating features of the present invention and are not intended to limit the scope of the present invention in any way.

### Example 1

Cartridge brass (UNS-C26000, 70% Cu/30% Zn) plates (10 cm x 10 cm squares, 2 mm thick) was cut from sheet stock and polished with 240 grit paper (Buehler, Lake Bluff, Ill.). Artificial seawater was Vatäanen nine salts solution (VNSS, pH 7.5) (G. Hernandez et al., Corrosion Science, 50, 603, 1994). Luria Bertani (LB, pH 6.5) medium is a rich growth medium made from 10 g tryptone, 5 g yeast extract, and 10 g NaCl per liter (T. Maniatis et al., “Molecular Cloning: A Laboratory Manual.” Cold Spring Harbor, 1982). Bacillus subtilis WB600 obtained from Dr. Sui-Lam Wong of the University of Calgary is a protease-deficient strain (kanamycin-resistant derivatives were used here) (X.-C. Wu, et al., J. Bacteriol. 173., 4952,1991). Bacillus licheniformis 9945a was obtained from the American Type Culture Collection. Biofilms on brass UNS-C26000 were developed in glass/teflon cylindrical continuous reactors in either LB or VNSS at about 30° C. with a liquid nutrient flow rate of about 0.2 mL/min (A. Jayaraman, et al., Appl. Microbiol. Biotechnol., 48, 11, 1997). The airflow was about 200 mL/min to headspace, the working volume of the reactor was about 100 mL or 150 mL and the exposed surface area of the test electrode was about 28.3 cm². The continuous reactors (sterile and inoculated) were conducted in the presence of about 100 μg/mL kanamycin to ensure sterility (except for B. licheniformis). A 1% (vol/vol) bacterial inoculum from a turbid, 16-hr culture was used for the continuous experiments.

### Example 2

A titanium counter electrode (11.3 cm² surface area) and autoclavable Ag/AgC1 reference electrode (Ingold Silver Scavenger DPAS model 105053334, Metler-Toledo Process Analytical, Inc., Wilmington, Mass.) were used to make electrical impedance spectroscopy measurments of biofilms on brass UNS-C26000, prepared as described in Example 1.

Electrochemical impedance data were obtained at the open-circuit potential E_{corr} in the frequency range of 20 kHz to 1.3 mHz using an IM6 Electrochemical Impedance Analyzer with a 16 channel cell multiplexer (Bioanalytical Systems-Zahner, West Lafayette, Ind.) running with THALES Impedance Measurement and Equivalent Circuit Synthesis / Simulation / Fitting Software interfaced to a Gateway Pentium GP6 300 MHZ computer (North Sioux City, S.Dak.).

The experiments carried out for brass UNS-C26000 in VNSS and LB medium are listed in Table I. Some tests have been performed in duplicate.

TABLE I

| | | | | Secreted |
|---|---|---|---|---|
| Exp. # | Medium | pH | Strain | inhibitor |
| 174 | VNSS | 7.5 | Sterile | |
| 239 | VNSS | 7.5 | Sterile | |
| 238 | VNSS | 7.5 | B. subtilis WB600 | |
| 176 | VNSS | 7.5 | B. subtilis WB600/pBE92- | polyaspartate |
| | | | polyaspartate | |
| 175 | VNSS | 7.5 | B. licheniformis | γ-polyglutamate |
| 166 | LB | 6.5 | Sterile | |
| 130 | LB | 6.5 | B. subtilis WB600 | |
| 131 | LB | 6.5 | B. subtilis WB600/pBE92- | polyaspartate |
| | | | polyaspartate | |
| 168 | LB | 6.5 | B. subtilis WB600/pBE92- | polyaspartate |
| | | | polyaspartate | |
| 132 | LB | 6.5 | B. licheniformis | γ-polyglutamate |
| 167 | LB | 6.5 | B. licheniformis | γ-polyglutamate |

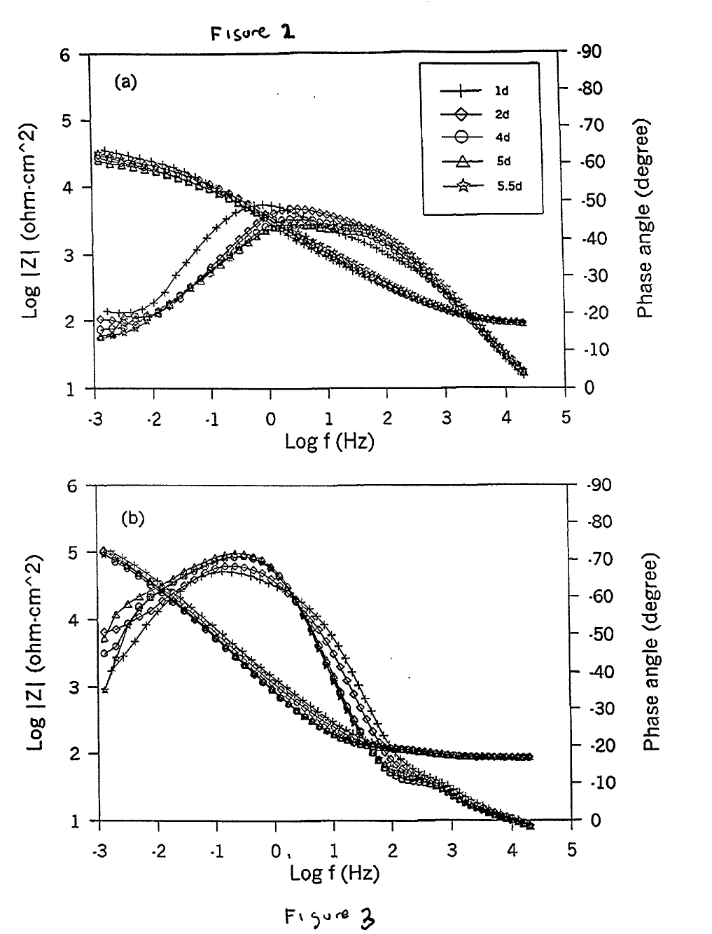

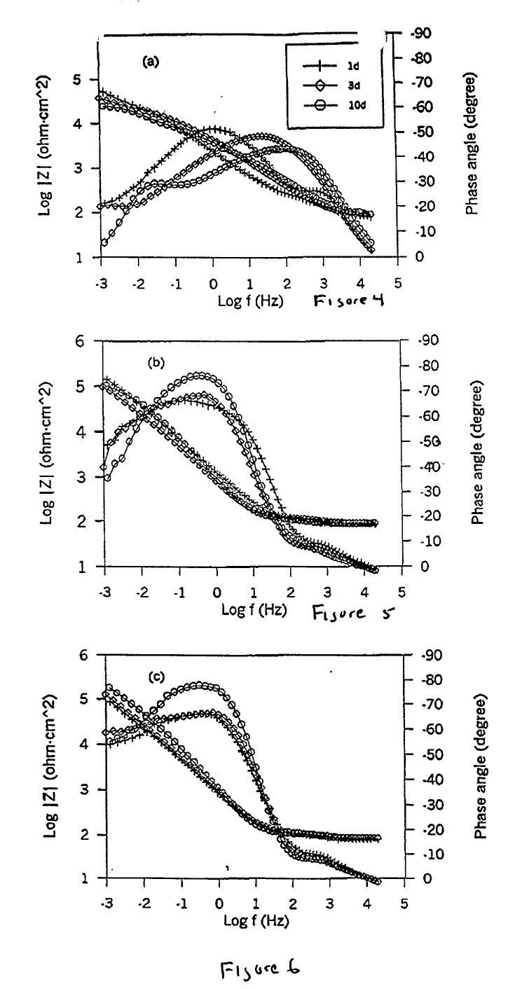

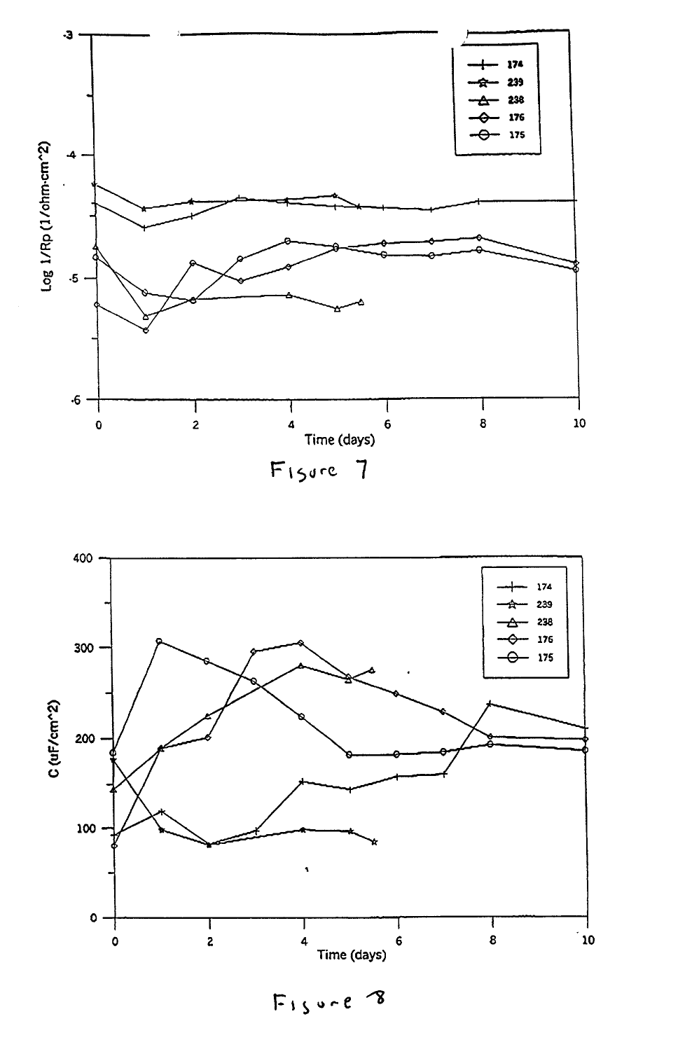

The Bode plots obtained in sterile VNSS, (pH 7.5) are shown in FIG. 2, while FIG. 3 shows the corresponding Bode plots in the presence of B. subtilis. A comparison of the impedance spectra in FIG. 2 with FIG. 3 demonstrates qualitatively that the presence of the biofilm provides corrosion protection. FIG. 4 shows impedance spectra obtained for brass after 1, 3 and 10 days exposure in VNSS, while FIGS. 5 and 6 illustrate the impedance spectra obtained in the presence of B. subtilis WB600/pBE92-polyasp, which produces polyaspartate and in the presence of B. licheniformis, which produced γ-polyglutamate, respectively.

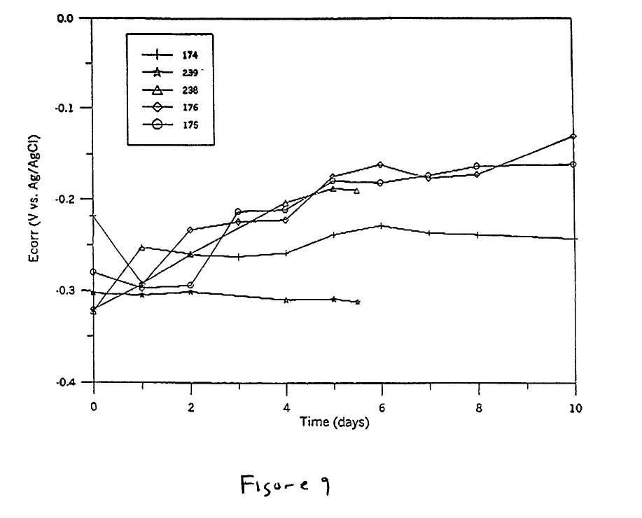

In very corrosive VNSS, impedance data were low and several time constants were observed as shown in FIG. 4. However, in the presence of biofilms, a large increase of the impedance was observed with mainly capacitive behavior as can be seen in FIG. 5 and FIG. 6. The time dependence of the normalized inverse polarization resistance 1/Rₚ, which is proportional to the corrosion rate is shown in FIG. 7, while the capacitance C is shown in FIG. 8. The corrosion rates for brass coated with biofilms were about the same, as illustrated by FIG. 7, and were lower than for brass alone. The capacitance C was slightly lower for the sterile solution in the initial phase of the tests. However, at the end of exposure, very similar values of C were obtained for all three solutions where brass was coated with a biofilm.

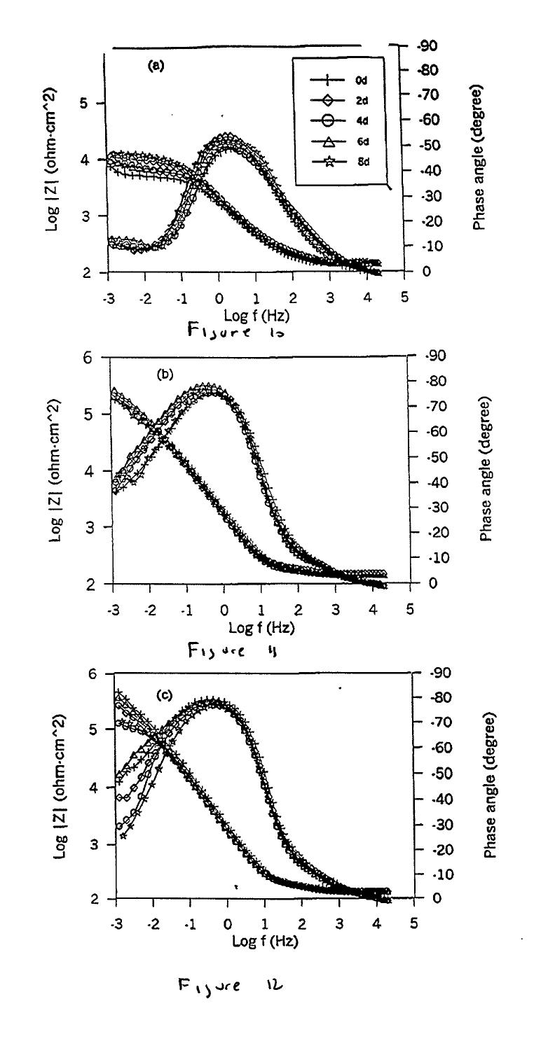

The ability of biofilms to protect brass UNS-C26000 in VNSS is not due to a reduction of the oxygen concentration at the brass surface since the corrosion potential (E_{corr}) increases with time. Thus, ennoblement of brass was observed in VNSS in the presence of a biofilm, as illustrated in FIG. 9. After 10 days, E_{corr} was lower by about 100 mV in VNSS without bacteria.

The sample exposed to VNSS was covered by a dark film, while the samples exposed to VNSS containing bacteria remained untarnished and did not show signs of corrosive attack. After removal of the corrosion products in a solution of H₂SO₄/Na₂Cr₂O₇, no indication of localized attack was found for the sample exposed to sterile VNSS. Thus, the corrosion process is assumed to have progressed by the commonly accepted mechanism of dezincification of brass.

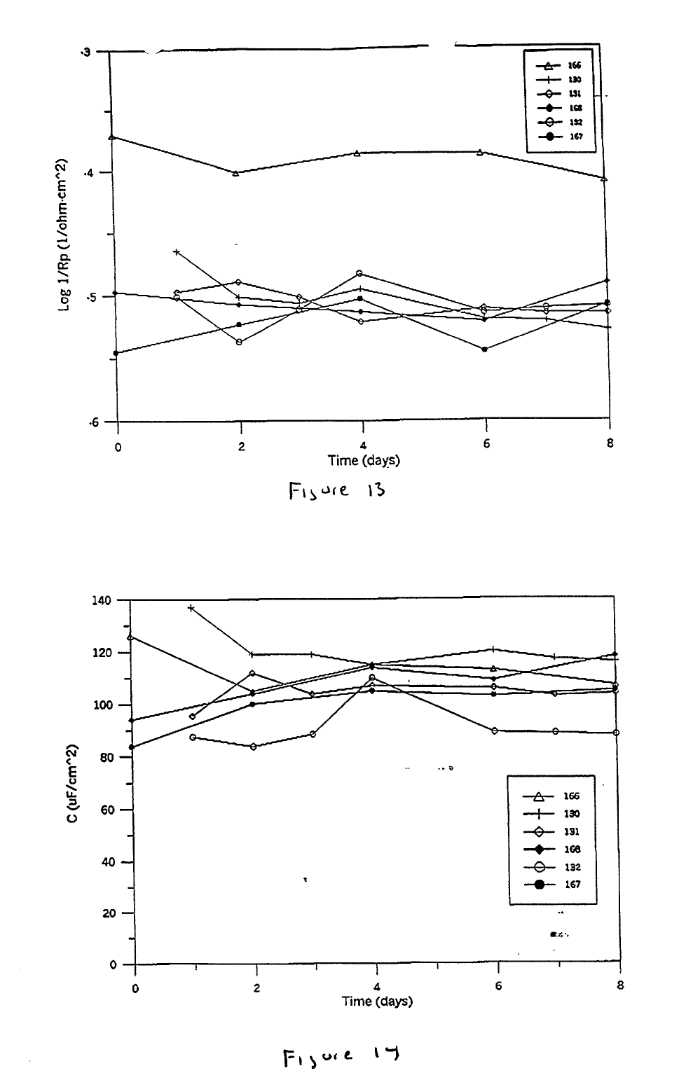

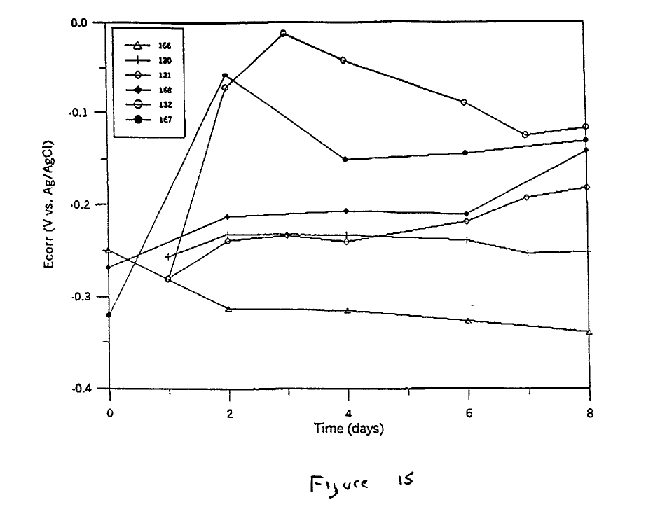

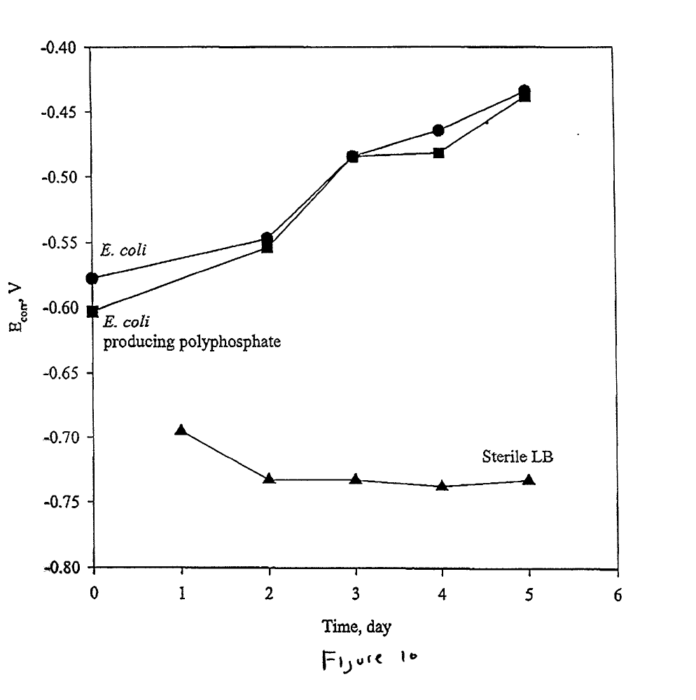

The experiments conducted in LB medium at pH =6.5 (Table I) produced similar results. The impedance spectra obtained in sterile LB medium, as shown in FIG. 10 were similar to those observed for diffusion controlled processes, which are described by the Warburg impedance in series with Rₚ, (Randles circuit). In the presence of biofilms producing polyaspartate (FIG. 11) or γ-polyglutamate (FIG. 12), the impedance was much higher with essentially capacitive behavior similar to the results obtained in VNSS (FIGS. 2-6). The time dependence of the relative corrosion rate expressed as 1/Rₚ and the capacitance C is shown in FIG. 13 and 14, respectively.

Corrosion rates were more than an order of magnitude higher in the sterile LB medium, than in the presence of the two biofilms, for which very similar corrosion rates were observed as can be seen by comparing FIGS. 10, 11 and 12. The Rₚ values determined in LB medium in the presence of the biofilms were similar to those observed for the same conditions in VNSS as shown in FIG. 13. The average value of Rₚ of about 10⁵ ohm/cm² corresponds to a corrosion rate of about 2 μm/years, which is quite low. The capacitance values were similar for all exposure conditions of Table I in LB medium (FIG. 14). Duplicate tests resulted in comparable values of Rₚ and C, respectively as can be seen in FIGS. 13 and 14. The results of FIG. 14 seem to indicate that formation of a biofilm prevents corrosive attack by unknown mechanism.

After exposure to sterile LB medium, the sample was covered by a dark film of corrosion product. When the film was removed in a solution of H₂SO₄/Na₂Cr₂O₇ no indication of localized attack was found. The samples used in the tests with bacteria remained untarnished and did not show any signs of corrosive attack. Ennoblement was also observed for these systems with a difference in E_{corr} of about 200 mV between the sterile solution (test #166) and the solution containing B. licheniformis producing γ-polyglutamate (tests #132 and 167) for which ennoblement seemed to be more pronounced than for B. subtilis WB600/pBE92-polyasp producing polyaspartate (tests #131 and 168) (FIG. 15).

The microorganisms used in this study of the corrosion behavior of brass UNS-C26000 in VNSS and LB medium were able to significantly reduce corrosion damage. The black film of corrosion products formed in sterile media was not observed in the presence of the bacteria. The observed corrosion protection is not due to a significant reduction of the oxygen concentration at the brass surface since this would have produced a shift of E_{corr} in the negative direction.

### Example 3

E. coli MV1184, plasmid pBC29, which contains the ppk polyphosphate kinase gene of E. coli that catalyzes the reversible transfer of a phosphate group from ATP to the polyphosphate chain and plasmid pEPO2.2, which contains the pst operon of E. coli which encodes the phosphate-specific transport system, were obtained from Professor Kato of Hiroshima University, Japan (Kato et al., Applied and Environmental Microbiology 59, 11 :3744, 1993, which is herein incorporated by reference). E. coli MV1 184 (pBC29 +pEP02.2) was constructed by electroporating the plasmids into E. coli MV1 184 strain. This recombinant is capable of secreting polyphosphate in the presence of IPTG (Fisher Scientific Co., Pittsburgh, Pa.), and is resistant to 25,μg/ml chloramphenicol (pEP02.2 plasmid) and 50 μg/ml ampicillin (pBC29 plasmid). E. coli MV 1184 is resistant to 10,μg/mL tetracycline. Both E. coli MV1184 and E. coli MV1184 (pBC29 +pEPO2,2) were inoculated from -80° C. glycerol stocks into 250 mL shaker flasks with 25 mL LB medium supplemented with necessary antibiotics, and grown overnight at 37° C. and 250 rpm (series 25 shaker, New Brunswick Scientific, Edison, N.J.) (Maniatis, et al., “Molecular cloning: A laboratory manual” Cold Spring Harbor Laboratory Press, Cold Spring Harbor, N.Y., 1982.

### Example 4

Artificial seawater (i.e., Vatäanen nen nine salts solution (VNSS)) was used to test the effect of 1 g/L purified polyphosphate (Sigma Chemical Co, St. Louis, Mo.) on the corrosion rate of mild steel. Ten cm squares (1.2 mm thick) of mild steel 1010 (UNS G10100) were cut from sheet stock (Yarde Metals, Bristol, Conn.) and polished with 240 grit polishing paper (Buehler, Lake Bluff, Ill.). The metal surfaces were cleaned by holding them under a stream of tap water and vigorously scrubbing them with a rubber stopper at the end of the continuous experiments.

A 1% (vol/vol) inoculum from a late-exponential phase culture was used for all continuous culture experiments. A continuous reactor system was designed and constructed for monitoring corrosion rates with electrical impedance spectroscopy in flow systems. As many as eight reactors have been monitored simultaneously. The metal sample formed the bottom of the reactor (the four corners of the metal sample were not part of the reactor) a glass cylinder (5.5 cm or 6.0 cm diameter) formed the walls of the system, and a 1 cm thick teflon plate (12.6 cm×12.6cm) formed the roof of the reactor. The working volume of the reactor was 100 mL or 150 mL with an airflow rate of 200 mL/min (FM1050 series flowmeter, (Matheson Gas Company, Cucamonga, Calif.). The growth temperature was maintained at 37° C. using heating tape wrapped around the reactor. Sterile medium was pumped continuously at a rate of 12 mL/hr using a Masterflex precision standard drive with a 10-turn potentiometer (Cole-Parmer, Niles, Ill.). The reactors (sterile and inoculated), were operated with necessary antibiotics to ensure sterility or the presence of the E. coli strain. Biofilms were allowed to develop for 15-18 hours in batch mode, then nutrients were added continuously, and biofilm development was monitored using electrochemical impedance spectroscopy. The sample specimen was at the bottom of the reactor with a titanium counter electrode at the center (3.8 cm in diameter, positioned 1.5 cm above the metal plate) and an autoclavable reference electrode (model 105053334 Ingold Silver Scavenger DPAS electrode, Mettler-Toledo Process Analytical Inc., Wilmington, Mass.) at the periphery (3.0 cm above the metal plate). All experiments were conducted at least in duplicate.

The polarization resistance (Rₚ) and open circuit potential data (E_{corr}) were obtained from ac impedance data using the BAS-Zahner IM6 interfaced to a Gateway PC computer running THALES software. Measurements were made over a frequency range of 20 kHz to 1.3 mHz. The experimental impedance spectra were analyzed using equivalent circuit (BC) analysis. Polarization resistance (Rₚ) is inversely proportional to the corrosion current density i_{corr} (or corrosion rate) (Stern et al., Journal of Electrochemical Society, 104:56, 1957). The Stem-Geary equation is given as:

$${i}_{corr} = \frac{{β}_{A} {β}_{C}}{2.303 ( {R}_{P} ) ( {β}_{A} {β}_{C} )}$$

where βₐ and β_{c} are the anodic and cathodic Tafel slopes, respectively. The advantage of using impedance spectroscopy is that corrosion rates of metals covered by a biofilm can be determined without disturbing the biofilm. Thus, the role of biofilms in preventing metal corrosion can be determined accurately.

Purified polyphosphate (1 g/L) was added to VNSS and found to decrease the corrosion rate (1/Rₚ) of mild steel nearly 5-fold compared to sterile VNSS at pH 7.5 at 30° C. The polyphosphate-containing medium was clear, and the metal in this medium was also relatively free of tarnish; in contrast, the medium which lacked polyphosphate was turbid (slightly brown color) and the metal was rusted in 3 days batch operation.

The corrosion behavior of mild steel in continuous reactors in the presence of the polyphosphate generated from genetically engineered bacteria, whose preparation was described in Example 3 (E. coli MV1184/pBC29+pEPO2.2) was then studied. For this strain to produce and secrete polyphosphate, phosphate and IPTG at the concentration of 0.5 mM must be added to the nutrient medium. The bacterium then converts the phosphate to polyphosphate and secretes polyphosphate. Hence, 0.1 to 5.0 g/L K₂HPO₄ was added to medium that was continually pumped to the reactor with a flow rate of 12 mL/h for both the polyphosphate-producing strain and the control Mv1184 which does not produce polyphosphate. In this way the benefit of polyphosphate formation for corrosion reduction was evaluated above the effect of phosphate alone.

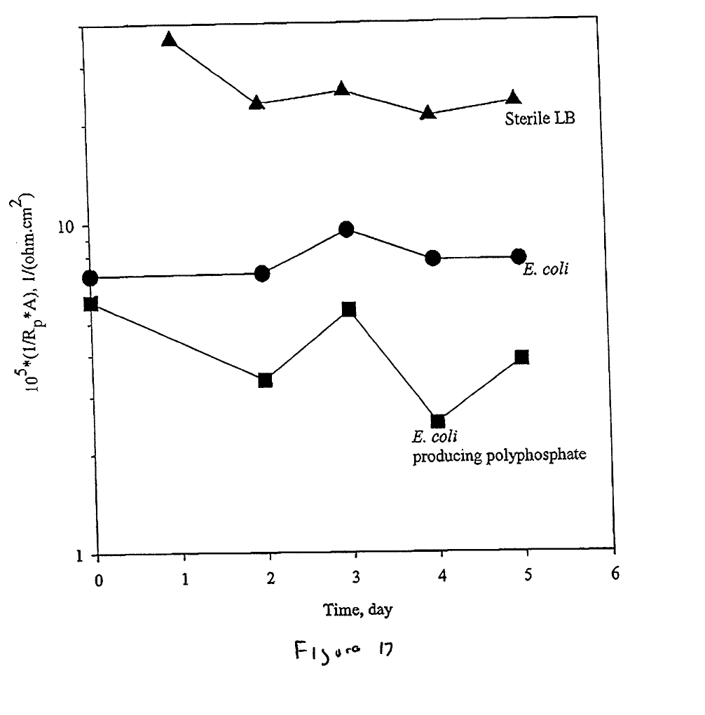

E. coli MV1184 (pBC29 +pEPO2.2) and E. coli MV1 184 both grew well, and FIG. 16 shows that the corrosion potential E_{corr} increased by 300-400 mV when compared to sterile controls as a result of biofilm formation (Jayaraman et al., Applied Microbiology and Biotechnology, 48:11-17, 1997). This significant shift toward more noble values indicates higher protective behavior of the surface film. The E_{corr} of mild steel increased continuously during the five days experiment

For mild steel with E. coli MV1184/(pBC29 +pEPO2.2), LB medium containing 0.1, 1.0 and 5 g/L K₂HPO₄ and 0.5 mM IPTG at pH 7.0 and 37° C. was used with continuous reactors so that polyphosphate production would be maximized. E. coli MV1184, which does not secrete polyphosphate was used as a biofilm forming control. The polarization resistance (Rₚ) of mild steel at different K₂HPO4 concentrations in LB medium is given in Table 2. The polarization resistance of mild steel in LB medium containing 0.1-5.0 g/L K₂HPO₄ was determined with a one time constant model (OTCM) or Warburg model and the average value of Rₚx A for the last 3-6 days of the 5-day experiment is given in Table 2.

A represents the polarization resistance multiplied by the exposed surface area (A) of the metal coupon (45.4 cm2) averaged over 3-6 days. Rₚ is obtained from the one time constant model.

TABLE 2

| Culture | K₂HPO₄, g/L | Rₚ × A, ohm/cm² |
|---|---|---|
| E. coli MV1184 | 0.1 | 8126 |
| E. coli MV1184 | 0.1 | 5334 |
| (pBC29 + pEP02.2) | | |
| E. coli MV1184 | 1 | 18,000 |
| E. coli MV1184 | 1 | 23925 |
| (pBC29 + pEP02.2) | | |
| E. coli MV1184 | 1 | 15,200 |
| E. coli MV1184 | 1 | 28,450 |
| (pBC29 + pEP02.2) | | |
| E. coli MV1184 | 5 | 25,151 |
| E. coli MV1184 | 5 | 24,879 |
| (pBC29 + pEP02.2) | | |

Impedance analysis showed that E. coli MV1184/pBC29+pEP02.2 (producing polyphosphate) containing 1 g/L K₂HPO₄ appears to decrease corrosion rate for mild steel 2.3-fold as compared to E. coli MV1184. However, there was no advantage in producing polyphosphate in LB containing 0.1 or 5 g/L K₂HPO₄.

FIG. 17 shows the time dependence of the fit parameters 1/Rₚ (relative corrosion rate) obtained for mild steel during exposure to E. coli cultures in LB for 5 days. Impedance analysis showed that the addition of MV1184 (pBC29+pEPO2-2) and MV1184 decreased the corrosion rate of mild steel 3.8 and 1.6 (averages of the last 4-day of 5 days experiment) as compared to sterile LB medium. Hence, a biofilm of genetically engineered E. coli MV1184 (pBC29+pEPO2-2) that produced polyphosphate was able to decrease the corrosion rate of mild steel 2.3-fold compared to E. coli MV1184 (based on the modeled results).

The surface appearance of the mild steel coupons after exposure to E. coli in LB and sterile LB was examined. Visual inspection showed the surface of mild steel was completely black (sterile LB medium). However, the mild steel was completely unaffected when a biofilm was present (all E. coli cultures); hence biofilm formation on the metal surface resulted in a decrease in corrosion of mild steel.

Finally, it should be noted that there are alternative ways of implementing both the process and apparatus of the present invention. For example, different bacteria may be used to form biofilms and these bacteria may secrete different anti-corrosive chemical compositions. Biofilms may be grown on different metals and different biofilms may be grown on metals in environments different than artificial seawater. Accordingly, the present embodiments are to be considered as illustrative and not restrictive, and the invention is not to be limited to the details given herein, but may be modified within the scope and equivalents of the appended claims.

What is claimed is:

1. A metal comprising:
a substrate with an exterior surface; and
a protective biofilm positioned on said exterior surface that reduces corrosion of said exterior surface;
wherein said metal is not steel, copper or aluminum.

2. The metal of claim 1, wherein said metal is brass UNS-C26000.

3. The metal of claim 1, wherein said biofilm is a bacterium.

4. The metal of claim 3, wherein said bacterium is an aerobe.

5. The metal of claim 4, wherein said bacterium is Bacillus subtilis or Bacillus licheniformis.

6. The metal of claim 1, wherein said biofilm is between about 10 μm and about 20 μm thick.

7. A method for reducing metal corrosion comprising:
providing a metal with an exterior surface;
applying on said exterior surface a protective biofilm that reduces corrosion of said exterior surface;
wherein said metal is not copper, aluminum or steel.

8. The method of claim 7, wherein said providing step includes the step of providing a metal that is brass UNS-C26000.

9. The method of claim 7, wherein said applying step includes the step of applying a protective biofilm that is a bacterium.

10. The method of claim 9, wherein said applying step includes the step of applying a bacterium that is an aerobe.

11. The method of claim 10, wherein said applying step includes the step of applying a bacterium that is Bacillus subtilis or Bacillus licheniformis.

12. The method of claim 7, wherein said applying step includes the step of applying a protective biofilm that is between about 10 μm and about 20 μm thick.

13. The method of claim 7, wherein said providing step includes the step of providing a metal that is immersed in a liquid.

14. The method of claim 13, wherein said providing step includes the step of providing a metal that is immersed in artificial seawater or Luria-Bertani medium.

15. A metal comprising:
a substrate with an exterior surface; and
a protective biofilm positioned on said exterior surface that reduces corrosion of said exterior surface;
wherein said protective biofilm is a bacterium that secretes a polyanionic chemical composition.

16. The metal of claim 15, wherein said metal is selected from the group consisting of aluminum, aluminum alloy, copper, a copper alloy, titanium, a titanium alloy, nickel and a nickel alloy.

17. The metal of claim 15, wherein said metal is steel.

18. The metal of claim 17, wherein said steel is mild steel-1010.

19. The metal of claim 15, wherein said bacterium is an aerobe.

20. The metal of claim 19, wherein said bacterium is E. coli.

21. The metal of claim 15, wherein said bacterium has been genetically engineered to secrete the polyanionic chemical composition.

22. The metal of claim 15, wherein said polyanionic chemical composition is polyphosphate.

23. The metal of claim 15, wherein said biofilm is between about 10 μm and about 20 μm thick.

24. A method for reducing corrosion comprising:
providing a metal with an exterior surface;
applying on said exterior surface a protective biofilm that reduces corrosion of said exterior surface;
wherein said protective biofilm is a bacterium that secretes a polyanionic chemical composition.

25. The method of claim 24, wherein said providing step includes the step of providing a metal that is selected from the group consisting of aluminum, a aluminum alloy, copper, copper alloy, titanium, a titanium alloy, nickel and a nickel alloy.

26. The method of claim 24, wherein said providing step includes the step of providing a metal that is steel.

27. The method of claim 26, wherein said providing step includes the step of providing a metal that is mild steel-1010.

28. The method of claim 24, wherein said applying step includes the step of applying a bacterium that is an aerobe.

29. The method of claim 28, wherein said applying step includes the step of applying a bacterium that is E. coli.

30. The method of claim 24, wherein said applying step includes the step of applying a bacterium that has been genetically engineered to secrete the polyanionic chemical composition.

31. The method of claim 24, wherein said applying step includes the step of applying a polyanionic chemical composition that is polyphosphate.

32. The method of claim 24, wherein said applying step includes the step of applying a biofilm that is between about 10 μm and about 20 μm thick.

33. The method of claim 24, wherein said providing step includes the step of providing a metal that is immersed in a liquid.

34. The method of claim 24, wherein said providing step includes the step of providing a metal that is immersed in artificial seawater or Luria-Bertani medium.
